(19) United States
(12) Patent Application Publication
(10) Pub. No.: US 2019/0281957 A1
(43) Pub. Date: Sep. 19, 2019

(54) Chair Sherpa

(71) Applicant: Michael Lee Chilton, Benton, KY (US)

(72) Inventor: Michael Lee Chilton, Benton, KY (US)

(21) Appl. No.: 16/411,333

(22) Filed: May 14, 2019

Related U.S. Application Data
(63) Continuation-in-part of application No. 16/154,571, filed on Oct. 8, 2018, now abandoned.
(60) Provisional application No. 62/569,267, filed on Oct. 6, 2017.

(51) Int. Cl. A45F 3/14; A61G 1/017; A61G 1/013

(52) U.S. Cl. CPC A45F 3/14; A45F 2003/142; A61G 1/013; A61G 1/017

(57) ABSTRACT

An evacuation chair is carried using shoulder straps attached to pad on the chair.

### CROSS REFERENCE TO RELATED APPLICATIONS

This application claims the benefit of U.S. Provisional Application Ser. No. 62/569,267 filed by Michael Lee Chilton on Oct. 6, 2017 and entitled “Chair Sherpa” and is a continuation in part of Ser. No. 16/154,571 by Michael Lee Chilton on Oct. 8, 2018, which is incorporated herein by reference.

### FIELD OF INVENTION

The invention relates to a new and improved way to carry an evacuation chair.

### BACKGROUND OF THE INVENTION

Evacuation chairs are heavy and cumbersome to lift up stairs in fire and other rescues. During emergencies, firefighters, paramedics, and others may carry evacuation chairs into disaster areas such as burning buildings in order to evacuate injured or people with mobility issues. Often these evacuation chairs are heavy and have to be carried up flights of stairs. In an emergency, carrying evacuation chairs quickly and efficiently is important. It is also important for the person carrying the evacuation chair to have the strength left to be able to remove someone in the chair. The present invention relates to a person carrying an evacuation chair.

### SUMMARY OF THE INVENTION

The present invention is a strap system for an evacuation chair.

### BRIEF DESCRIPTION OF DRAWINGS

FIG. 1 is a chair with pads attached.

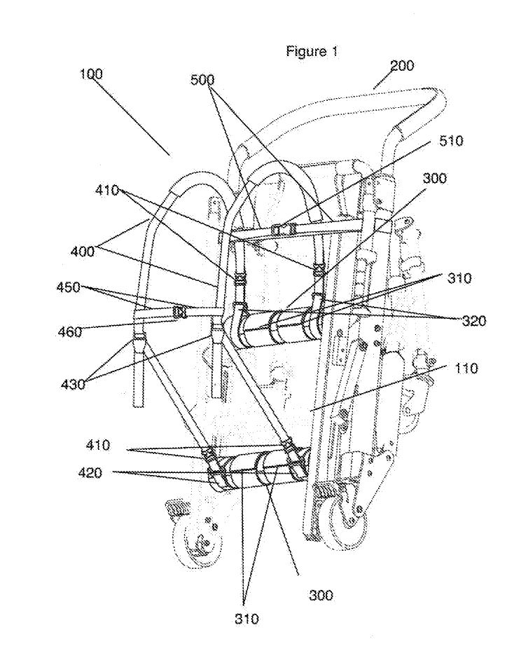

FIG. 2 is a view of chair straps.

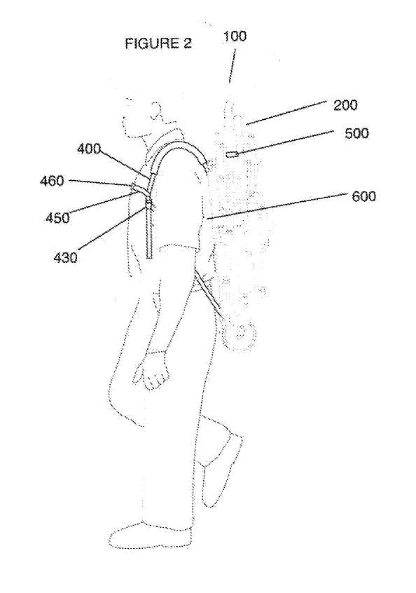

FIG. 3 is a side view of the chair with straps.

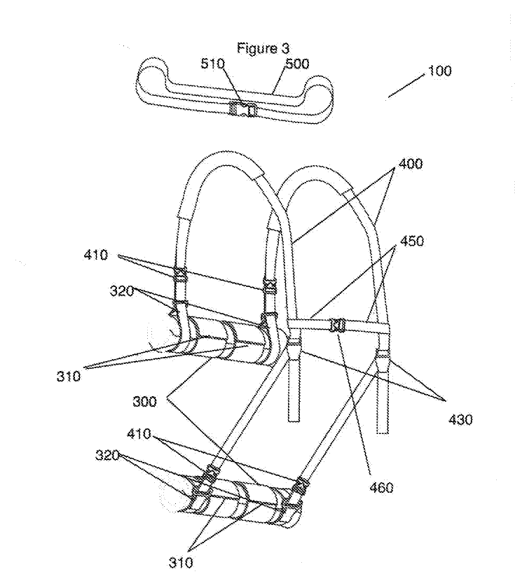

FIG. 4 is a side view of the chair with straps.

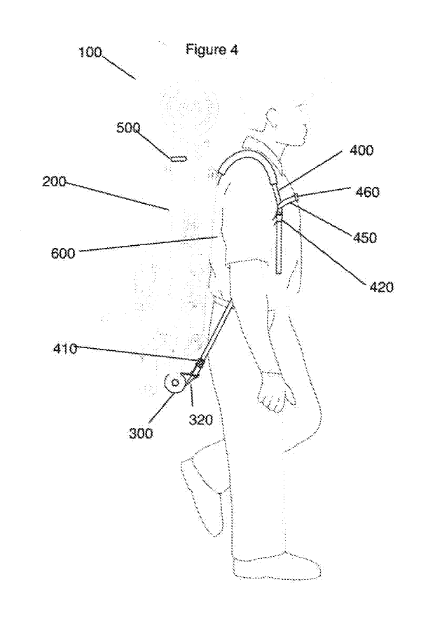

FIG. 5 is a plan view of the straps and pads.

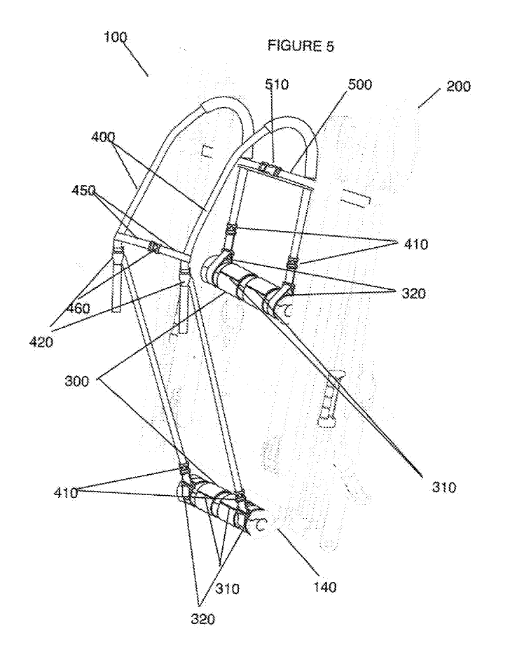

### DETAILED DESCRIPTION OF THE INVENTION

The present invention is an evacuation chair system 100 put on the evacuation chair 200. An evacuation chair 200 of various sizes and shapes can be used to evacuate people with mobility issues in disasters. A padding 300 can be formed in the shape of a cylinder. The cylinder is wrapped around a member 110 of the evacuation chair. The member 110 is a bar, rod, a cross-piece or other piece of the chair. The member 110 could be horizontal or vertical. The padding 300 can be made of fabric alone. The padding 300 can be made of a combination of foam in addition to fabric. The padding 300 can be an irregular shape or a pillow shape. The padding 300 encloses the fabric with one or more closers 310 to keep it wrapped around the member 110. Attached on the padding 300 is one or more shoulder straps 400. A shoulder strap 400 is attached to a padding 300 or member 110 on each end of the shoulder strap 400. The shoulder strap 400 can be attached with a fastener 410. The fastener 410 can be a loop around the padding 300 or member 110. The fastener 410 can be a clip, snap, buckle or similar attached to a loop around the padding 300 or member 110.

Each of the shoulder straps 400 has attached to the shoulder strap 400 one end of a center strap 450. The center strap 450 attached to the shoulder strap 400 is fastened using a center strap fastener 460 on the other end that is not attached to the shoulder strap 400. The center strap 450 can be horizontal to the ground and can be attached across the chest or other parts of the body.

The stabilizing strap 500 has a stabilizing fastener 510. The stabilizing strap 500 can be attached around or through the evacuation chair 200. The stabilizing strap 500 can also be attached around or through the evacuation chair 200 and in between the shoulder straps 400 and a body 600 of the person wearing the evacuation chair system 100.

The shoulder straps 400 can be padded and adjustable. The additional material for padding the shoulder straps could be placed anywhere along the shoulder strap 400. An adjustable part 430 of the shoulder straps can be placed anywhere along the shoulder strap 400.

In a preferred embodiment, a padding 300 wraps around both an upper horizontal frame 120 and a lower horizontal frame 130. The padding 300 is secured with a closer 310. The fasteners can be hook and eye, button, snap, or other fastening elements. The padding 300 also has loops 320 so that a shoulder strap 400 can attach to the loops 320 with a strap fastener 410. A shoulder strap 400 also includes an adjustment buckle 430. Each shoulder strap 400 also includes a chest strap 410 with a chest strap fastener 420 attaching each shoulder strap 300 together. The chest strap fastener 420 can be any type of clip, side quick release, D ring, cobra latches and other fastener.

In another preferred embodiment, a padding can wrap around a handle 140 or the uppermost horizontal portion of the evacuation chair 200 when used as a chair but when carried upside down can be the lowermost portion of the evacuation chair 200. One model of evacuation chair 200 when folded can be carried upside down to the way the another model of the evacuation chair 200 is carried when folded. The evacuation chair 200 does not have to be folded when carried but must have one or more horizontal members 110 to which the shoulder straps 400 may be attached.

What is claimed is:

1. A system of carrying an evacuation chair wherein one or more padding is attached around a member extending horizontally on an evacuation chair frame, the padding is attached with a closer, a fastener attaches each end of one or more shoulder straps to the padding, a chest strap is attached to each shoulder and fastened across a body in the front, in between the body and the shoulder straps is fastened with a fastener a stabilizing strap, the stabilizing strap is also around the evacuation chair.

2. An apparatus for carrying an evacuation chair wherein one or more padding is attached around a member extending horizontally on an evacuation chair frame, the padding is attached with a closer, a fastener attaches each end of one or more shoulder straps to the padding, a chest strap is attached to each shoulder and fastened across a body in the front, a stabilizing strap is placed around the evacuation chair and over the stabilizing straps.
